(19) United States
(12) Patent Application Publication
(10) Pub. No.: US 2026/0004324 A1
(43) Pub. Date: Jan. 1, 2026

(54) Enriched Presentation and Waste Reduction for Autonomous Provisioning of Goods and Services

(71) Applicant: Applied Electric Vehicles Ltd, Scoresby (AU)

(72) Inventors: Aleks Witko, Mont Albert (AU); Marc Alexander, Croydon Hills (AU)

(73) Assignee: Applied Electric Vehicles Ltd, Scoresby, VI (AU)

(21) Appl. No.: 18/758,440

(22) Filed: Jun. 28, 2024

(51) Int. Cl. G06Q 30/0251; G06Q 10/087

(52) U.S. Cl. CPC G06Q 30/0266; G06Q 10/087

(57) ABSTRACT

Enriched presentation and waste reduction techniques for the autonomous provisioning of goods and services are described. In one or more implementations, a promotion pod of a system includes a display screen for multimedia content, a presentation surface for a particular item, and lights to illuminate the presentation surface or the item displayed thereon. A processor is configured to control each system component of the promotion pod to provide a presentation environment for a particular item. For example, the processor controls the display screens to display promotional multimedia associated with the item. In some examples, the item is displayed without packaging (e.g., shoes are displayed without a shoebox). In this way, nearby pedestrians are provided an enriched, interactive experience and may purchase products in person with reduced or no packaging.

### BACKGROUND

Many retail stores use various tactics to attract customers and provide an interactive experience. For example, they may display high-value or popular products, such as perfumes, out of their original packaging with advertising media. Additionally, they may offer samples of the product to potential customers. This way, retailers can draw attention to and enhance the presentation of certain goods or services. However, with the increasing trend of consumers purchasing products from online or remote marketplaces, manufacturers and vendors are losing the ability to provide these interactive experiences to attract new customers.

Another issue that has emerged is that goods ordered online are typically delivered in their original packaging (from the manufacturer or distributor) along with shipping packaging. The shipping packaging often includes cardboard boxes surrounding the original packaging with additional packaging material inside. Such shipping packaging undermines the original presentation of the goods, diminishes the customer's initial experience, and increases waste.

### BRIEF DESCRIPTION OF THE DRAWINGS

FIG. 1 illustrates non-limiting example environment where a vehicle provides an enriched presentation and waste reduction for the autonomous provisioning of goods and services.

FIG. 2 is a block diagram of a non-limiting example of a vehicle system that provides an enriched presentation and waste reduction for the autonomous provisioning of goods and services.

FIG. 3 depicts an example block diagram for implementing techniques for an enriched presentation and waste reduction for the autonomous provisioning of goods and services.

FIGS. 4A-4C illustrate non-limiting examples of a vehicle system that enables an enriched presentation and waste reduction for the autonomous provisioning of goods and services.

FIG. 5 illustrates another non-limiting example of a vehicle system that enables an enriched presentation and waste reduction for the autonomous provisioning of goods and services.

FIG. 6 illustrates a non-limiting example of a vehicle that enables an enriched presentation and waste reduction for the autonomous provisioning of goods and services as part of a delivery service.

FIG. 7 illustrates another non-limiting example of a vehicle that enables an enriched presentation and waste reduction for the autonomous provisioning of goods and services as part of a delivery service.

FIG. 8 illustrates a non-limiting example of a vehicle system that enables an enriched presentation and waste reduction for the autonomous provisioning of goods and services via an application on an external computing device.

FIG. 9 depicts a procedure for implementing the enriched presentation and waste reduction for the autonomous provisioning of goods and services.

### DETAILED DESCRIPTION

As online transactions become more popular, manufacturers and vendors have fewer opportunities to create interactive experiences that drive sales. Moreover, most online purchases are delivered inside their original packaging and additional shipping packaging. Typically, multiple items are included in a single, larger package, which further understates the initial presentation and effect of the delivery as the items are obscured by at least one layer of packaging. Additionally, these delivery techniques use extra packaging materials such as cardboard boxes, air-filled plastic wrap, packing peanuts, and packing paper, often not recycled and leading to additional waste.

Manufacturers and vendors have responded to changing trends in consumer behavior by deploying automated kiosks that function like vending machines. These machines offer a wide range of products, with little to no advertising or promotional material. While this approach may provide a more interactive purchasing experience with less packaging than online purchases, the machines must be restocked periodically. In addition, the products remain behind a barrier and in their original packaging, limiting the customer's experience. Alternatively, some businesses opt for small or seasonal displays at fairs, outdoor markets, or festivals. While such pop-up approaches offer an interactive experience for potential customers, they require setup and maintenance expenses such as rent, transportation fees, and employee costs, which may outweigh the benefits.

In contrast, this document describes techniques for enriched presentation and waste reduction for the autonomous provisioning of goods and services. An example system, which may be an autonomous vehicle, includes multiple display screens displaying multimedia content visible from outside the system. The system also includes a presentation surface and lights to illuminate the presentation surface, a portion of the display screens, or an area near the system. A processor is configured to control each system component to provide a promotion environment for a particular good (e.g., a new gaming console) or service (e.g., kitchen remodeling). The processor controls the display screens to display marketing information associated with the good or service (e.g., brand name, logo, color scheme, trademark, trade dress, advertisement images and videos, or other promotional material). The processor also controls the lights to illuminate the good or a portion of the screens and internal machinery (e.g., a robotic arm, humanoid robot, or moveable member) to place the good, a replica thereof, or a portion thereof on the presentation surface with at least a portion of its original packaging removed. In some examples, the product is displayed without packaging (e.g., shoes are displayed without a shoebox). In this way, nearby users are provided an enriched, interactive experience at a local festival, walking in a crowded environment (e.g., a popular park or square for workers at lunchtime), or receiving a package delivery. In addition, users can purchase or receive products with little to no packaging to enhance the initial impression and reduce waste.

As one example scenario, an autonomous vehicle is configured to promote consumer electronics in busy urban areas during peak pedestrian times, such as lunch hour or the end of the workday. The autonomous vehicle may advertise a new gaming console during the holiday season. The display screens showcase the manufacturer and product names, play advertising videos, and display promotional images. The vehicle's lights highlight the gaming console on the presentation surface, which may extend beyond the vehicle to enhance visibility or interactivity. Other lights can draw attention to the vehicle or specific display screens. Additionally, the lights can project onto the ground to attract pedestrians and provide further advertising.

This interactive experience allows interested buyers to purchase the gaming console via an interactive screen or smartphone app and receive their purchase immediately, without any packaging. To be environmentally responsible, the autonomous vehicle may include a bin or locker to collect and recycle unwanted packaging material. In some implementations, the vehicle may have a humanoid robot, robotic arm, or human-machine interface to deliver purchased products, answer questions, place the gaming console on the display stand, secure a product while the autonomous vehicle is moving, and assist with device setup. Such autonomous provisioning systems enable manufacturers to promote their new products and increase customer awareness in a targeted, effective, efficient, and customizable manner. Additional implementations and use cases are described throughout this document.

In some aspects, the techniques described herein relate to a system that includes a promotion pod configured to provide a presentation environment for an item that is or is representative of a good or service. The promotion pod includes a display screen configured to display multimedia content visible from outside the system; a presentation surface configured to show an item, the item being a good or service; and a light configured to illuminate at least a portion of the promotion pod. The system also includes a processor configured to control the display screen to display promotional information associated with the item; cause the light to illuminate the item or a portion of the promotion pod; and control internal machinery of the promotion pod to place the item on the presentation surface.

In some aspects, the techniques described herein relate to a system wherein the system is an autonomous vehicle and the processor is further configured to autonomously setup the presentation environment upon arriving at a destination.

In some aspects, the techniques described herein relate to a system wherein the processor is further configured to setup a first presentation environment at a first time or a first location for a first item with first promotional information associated with the first item and setup a second presentation environment at a second time or a second location for a second item with second promotional information associated with the second item. The second presentation environment, the second item, and the second promotional information are different than the first presentation environment, the first item, and the second promotional information, respectively. And at least one of the second time or the second location being different than the first time or the first location, respectively.

In some aspects, the techniques described herein relate to a system wherein the promotional information includes at least one of a brand name, logo, color scheme, trademark, trade dress, advertisement image, or advertisement video associated with the item.

In some aspects, the techniques described herein relate to a system wherein the promotional information further includes a personalized image, video, or audio message for a nearby user.

In some aspects, the techniques described herein relate to a system wherein the item is showed on the presentation surface without packaging.

In some aspects, the techniques described herein relate to a system wherein the item is mechanically attached to the presentation surface and the processor is further configured to control a locker or dispenser mechanism of the system to provide a purchased item to a user from an internal inventory, the internal inventory not being visible from outside the system.

In some aspects, the techniques described herein relate to a system wherein the lights include one or more multi-wavelength light emitters having adjustable brightness or wavelength characteristics.

In some aspects, the techniques described herein relate to a system wherein the system further includes an audio system to play audio messages related to the item or the promotional information associated with the item.

In some aspects, the techniques described herein relate to a system wherein the system further includes a human-machine interface configured to allow nearby users to purchase the item or obtain more information about the item.

In some aspects, the techniques described herein relate to a system wherein the processor is further configured to control the display screen, light, and presentation surface based on instructions received from a remote computer system.

In some aspects, the techniques described herein relate to a system wherein the system further includes a humanoid robot, robotic arm, or robotic equipment that remove the item from associated packaging material; receive and stow the packaging material from a user; retrieve the item or a copy of the item for delivery to the user; or display a different item on the presentation surface.

In some aspects, the techniques described herein relate to a system wherein the system includes the humanoid robot that also answers questions from the user; performs a function associated with the item; or completes purchases of the item for the user.

In some aspects, the techniques described herein relate to a system wherein it further includes an inventory tracking system configured to determine whether the item is removed by a user from the presentation surface or a locker of the system; and the processor is further configured to charge the user for the item in response to a purchase transaction being completed on a human-machine interface of the system or via a remote computer system.

In some aspects, the techniques described herein relate to a method for providing a presentation environment for an item that is or is representative of a good or service, the method including autonomously operating, by one or more processors of a vehicle system, a vehicle to arrive at a location; controlling internal machinery of the vehicle to place the item on a presentation surface of the vehicle, the item being visible from outside the vehicle; controlling one or more display screens to display promotional information associated with the item; and controlling one or more lights to illuminate the item or a portion of the presentation environment.

In some aspects, the techniques described herein relate to a method wherein the presentation environment is autonomously setup by the vehicle system before raising a cover covering the one or more display screens, the presentation surface, or the one or more lights.

In some aspects, the techniques described herein relate to a method wherein the method further includes setting up a first presentation environment at a first time or a first location for a first item with first promotional information associated with the first item; and setting up a second presentation environment at a second time or a second location for a second item with second promotional information associated with the second item, with: the second presentation environment, the second item, and the second promotional information being different than the first presentation environment, the first item, and the second promotional information, respectively; and at least one of the second time or the second location being different than the first time or the first location, respectively.

In some aspects, the techniques described herein relate to a method wherein the vehicle further includes a humanoid robot, robotic arm, or robotic equipment; and the method further includes at least two of following actions performed by the humanoid robot, the robotic arm, or the robotic equipment: removing the item from associated packaging material; receiving and stowing the packaging material from a user; retrieving the item or a copy of the item for delivery to the user; or displaying a different item on the presentation surface.

In some aspects, the techniques described herein relate to a method wherein the vehicle includes the humanoid robot; and the method further includes an additional action performed by the humanoid robot: answering questions from the user; performing a function associated with the item; or completing a purchase of the item for the user.

In some aspects, the techniques described herein relate to a computer-readable storage medium comprising instructions that, when executed by one or more processors, cause a vehicle control system of a vehicle to autonomously operate the vehicle to arrive at a location; open a locker of the vehicle to deliver a package to a user; control internal machinery to place an item different from the package on a presentation surface of the vehicle, the item being visible to the user from outside the vehicle; control one or more display screens to display promotional information associated with the item; and control one or more lights to illuminate the item.

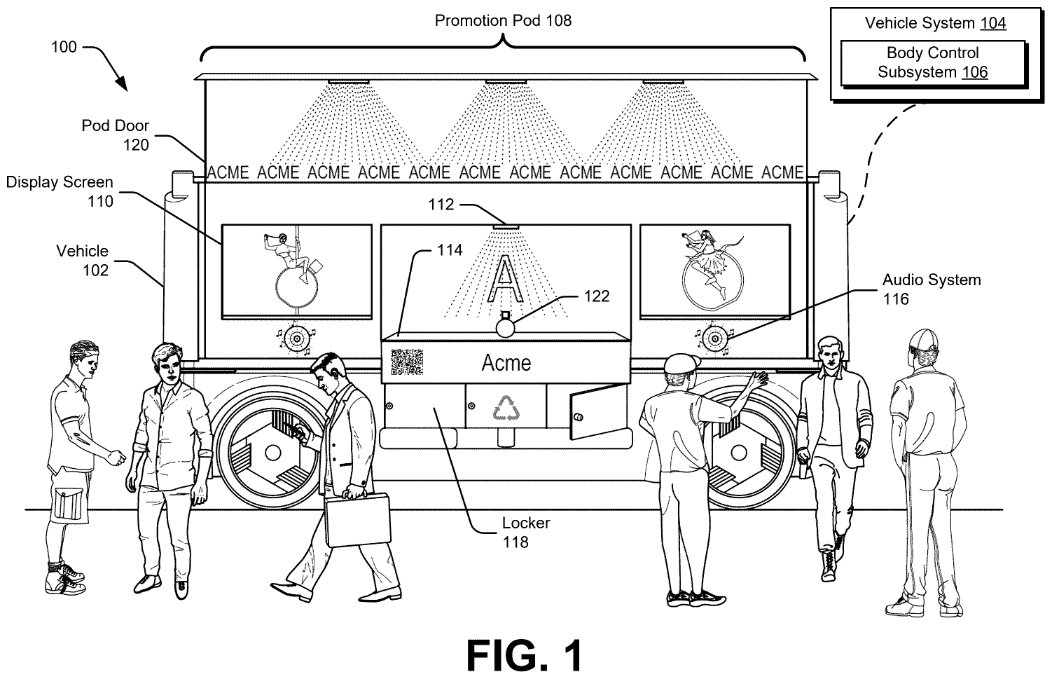

FIG. 1 illustrates a non-limiting example environment 100 where a vehicle 102 provides an enriched presentation and waste reduction for the autonomous provisioning of goods and services. The environment 100 includes any type of vehicle operating environment, such as a roadway, a traffic scenario, an off-road area (e.g., a construction site, a festival area, or a recreational area), in the air, on the water, in space, and other public or private spaces, to name a few. The vehicle 102 may be any type, including ground vehicles (e.g., trucks, cars, vans, tractor-trailers, tanks), air vehicles, rail vehicles, marine vehicles, space vehicles, or other vehicle types. Vehicle 102, in at least one example, is unmanned (e.g., autonomously controlled, remotely controlled). In at least one other example, vehicle 102 is manned (e.g., semi-autonomously controlled).

The vehicle 102 includes a vehicle system 104, which generally includes multiple electronic systems configured to interface with the vehicle's electromechanical components to implement processor-based vehicle functions and processor-driven operations, such as promoting and presenting goods and services in the environment 100. The vehicle system 104 includes a vehicle network that operatively couples a plurality of vehicle subsystems to a control system. For example, the vehicle subsystems represent a plurality of edge devices on the vehicle 102, which are in communication with the vehicle network and the control system to control vehicle components that operate in coordination to execute vehicle operations based on the network communication.

One example of a vehicle subsystem includes but is not limited to a body control subsystem 106 (e.g., for controlling lights, doors, display screens, and other vehicle components). Specifically, the body control subsystem 106 controls components of a promotion pod 108 of the vehicle 102. The promotion pod 108 is configurable for promoting goods or services in crowded areas or as part of a delivery operation. In this way, the vehicle 102 provides enriched presentations and waste reduction for autonomous provisioning.

In the illustrated implementation of FIG. 1, the promotion pod 108 includes one or more display screens 110, lights 112, presentation surfaces 114, audio systems 116, and lockers 118 for promoting and displaying a good 122 (e.g., perfume, shoes, smartphone, laptop, tablet, or tools) or service (e.g., prepared meals, cocktail service, home remodeling). The promotion pod 108 also includes a pod cover 120 that, when lifted, reveals the promotion components. In this way, these exterior-facing components are protected as the vehicle 102 travels in between locations but are then visible to nearby users once it is parked and ready for autonomous provisioning. In other implementations, the body control subsystem 106 controls additional or fewer devices or components. For example, the body control subsystem 106 may also control a human-machine interface, inventory tracking system, and/or robotic equipment (e.g., a humanoid robot or robotic arm) to assist with the promotion environment.

The display screens 110 are controllable to provide images and/or videos related to the good 122 or service being promoted. In particular, display screens 110 may be employed to play multimedia content. For example, the display screens 110 display the manufacturer's or product's name, trademark, logo, or color scheme, play an advertisement video related to the good 122 or service, or provide one or more images promoting the good 122 or service. The display screens 110 may also be controlled to adhere to a color scheme associated with the manufacturer, product, or service. In the illustrated example of FIG. 1, the promotion pod includes five display screens 110: one screen on an interior portion of the pod cover 120, three screens on the vehicle's side, and a last screen on an exterior portion of the presentation surface 114. The promotion pod 108 may include additional or fewer display screens in other implementations in the same or different locations.

The lights 112 illuminate or emphasize the good 122, the vehicle 102, a portion of the display screens 110, or an area (e.g., the ground) to the side of the vehicle 102. Lights 112 generally include an array (e.g., one-dimensional or two-dimensional array) of individual single-or multi-wavelength light emitters (e.g., light-emitting diode (LED) bulbs). In environment 100, the promotion pod 108 includes lights 112 in the raised pod cover 120 to emphasize the top screen and/or the vehicle 102 as a whole and other lights 112 in an interior portion to illuminate the presentation surface 114 or good 122.

In other implementations, the lights 112 may include laser or coherent light sources, projectors, single-wavelength or multi-wavelength laser or coherent light sources. In some implementations, the laser emitters are coherent LEDs. The body control subsystem 106 controls the individual light emitters to emit light with a particular brightness or wavelength characteristic from a range of available brightness and/or wavelength characteristics. In particular, the intensity of anyone of blue (B), green (G), red (R), yellow (Y), white (W), or other light wavelengths can be varied for individual light emitters to shift the brightness or wavelength characteristics of the lights 112. For example, multi-wavelength light emitters may include RGB or RGBW emitters, which mix aspects of red, green, blue, and/or white emitters to achieve a specific color temperature of white light (e.g., between 2000 and 6500 K) to illuminate an object or area with sufficient brightness or color temperature. In addition, white light can be mixed with one of R, G, B, and/or Y LEDs to provide pastel colors at higher brightness levels than a single color emitter alone.

The presentation surface 114 provides a platform or other surface on which the good 122, a replica thereof, or a product representative of a service is displayed. In the illustrated implementation of FIG. 1, the presentation surface 114 folds down or extends laterally to project away from the vehicle side. In other implementations, the presentation surface 114 is provided as part of a recess area on the vehicle side. Additional goods (e.g., additional units of the same or a different good) may be stored in the structure providing the presentation surface. These additional goods may be moved to the presentation surface 114 in multiple manners, including using a robotic arm, humanoid robot, or moveable machinery.

The audio system 116 includes one or more speakers to produce sound (e.g., individualized messages, advertisements) to nearby individuals. The audio system 116 or its speakers can come in various configurations, each tailored to reproduce specific parts of the audible spectrum. For example, the audio system 116 can be controlled to play a prerecorded advertisement for the good or service being marketed. In other implementations, the audio system 116 plays individualized messages for users in relation to goods being delivered, the user's profile and other information, or goods available for purchase.

The lockers 118 provide an enclosed space to store additional goods, collect packaging materials, or hold inventory for an enhanced presentation at a later time or different location. The body control subsystem 106 may control whether individual lockers 118 are locked, open, and/or closed. In the illustrated implementation, the promotion pod 108 includes three lockers 118 below the presentation surface 114, with one dedicated to collecting unwanted packaging. In other implementations, the promotion pod 108 or a different portion of vehicle 102 may include fewer or additional lockers in the same or different locations.

Other examples of vehicle subsystems include a propulsion or motion subsystem (e.g., providing motion control), drive subsystem (e.g., providing autonomous or semi-autonomous motion control), transmission subsystem, powertrain subsystem, human-machine interface (HMI) subsystem (e.g., for receiving user input regarding the enhanced presentations, interacting with potential customers, accepting driver input, receiving occupant input, or controlling infotainment of the promotion pod 108), remote entry or remote start subsystem, braking subsystem (e.g., providing brake control), an electronic stability control (ESC) subsystem, and communication subsystem for handling on-board and/or offboard communications (e.g., data and telemetry, vehicle-to-vehicle, vehicle-to-everything, cellular, Bluetooth). Further examples include but are not limited to an ADAS, steering subsystem (e.g., providing steering control), active suspension subsystem, fuel management subsystem, battery management subsystem (e.g., providing traction energy, managing battery usage and charging control), power distribution subsystem, subsystem), alarm subsystem, payload subsystem, and extensible-assembly control subsystem (e.g., pod control, exterior tool control), and any other electronic-based subsystem of the vehicle 102 that is controllable by the control system.

The vehicle system 104 includes one or more central control units that are electronic circuits for processing instructions to execute control routines on the vehicle. In particular, processor execution of the control routines enables the central control units to manage vehicle operations implemented by the edge devices, including the body control subsystem 106. The central control units and edge devices include a memory that stores instructions for execution by the processors to redundantly control the vehicle operations or implement vehicle functions in furtherance of the vehicle operations. For example, the central control units and/or the edge devices each include a memory circuit that stores instructions and data for executing a program (e.g., software, firmware), controlling the promotion pod 108, and coordinating system components to provide an enriched presentation of goods and services. In one or more implementations, the memory corresponds to semiconductor memory, where data is stored within memory cells on one or more integrated circuits. The respective memory of each central control unit and/or edge device is used to store information, such as for immediate output to the vehicle network.

In at least one example, the memory of the central control units and/or the edge devices corresponds to or includes volatile memory, examples of which include random-access memory (RAM), dynamic random-access memory (DRAM), synchronous dynamic random-access memory (SDRAM), static random-access memory (SRAM), and memristors. The memory of each of the central control units and/or the edge devices is configurable with any number of memory (e.g., physical memory) without departing from the spirit or scope of the described techniques. Alternatively or in addition, the memory of each of the central control units and/or the edge devices corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto-resistive random-access memory (MRAM). Further examples of memory configurations include low-power double data rate (LPDDR), also known as LPDDR SDRAM. The memory of each central control unit and/or edge device is configurable in various ways to support vehicle controls.

In the illustrated example environment 100, vehicle 102 is parked in a busy area with nearby pedestrians. For example, environment 100 may be a music festival, arena parking lot, park, visitor attraction area, or other densely-occupied location. Once parked, the vehicle system 104 provides instructions to the body control subsystem 106 and the promotion pod 108 to provide an enriched, interactive presentation of the good 122, which is perfume in this example. In particular, the pod cover 120 is raised or opened to expose the display screens 110, presentation surface 114, and audio system 116. The good 122 or a sample thereof is placed on the presentation surface 114, which extends out from a side of the vehicle in this example. The display screens 110 on the inside of pod cover 120, and the exterior of the presentation stand indicate the perfume's manufacturer or brand name. The display screen 110 behind the perfume displays the manufacturer's logo, while the two display screens 110 next to it, play advertisement images or videos for the perfume. The lights 112 illuminate the perfume and the promotion pod generally, and the audio system 116 plays audio messages synced up with the advertisements or to draw attention to the promotion pod 108. One locker 118 stores additional perfume bottles (inside or out of the original packaging), and another locker 118 collects unwanted packaging from purchasers.

Nearby users may sample the perfume or purchase it. For example, the display screen 110 below the presentation surface 114 may display a quick response (QR) code, allowing users to navigate to a website or app UI screen that allows them to purchase the displayed good 122 for immediate or later delivery. Alternatively, the promotion pod 108 may include a human-machine interface (HMI) screen to allow users to make purchases. Once a user completes a purchase, the website, app, or HMI screen may instruct them to take the perfume on the presentation surface 112 or take a packaged or unpackaged copy from a respective locker 118. If the user takes the perfume from the presentation surface 114, the internal machinery of the promotion pod 108 may place a perfume bottle on the presentation surface 114. For example, a humanoid robot or robotic arm may retrieve another bottle behind the presentation surface and place it thereon. In other implementations, a portion of the presentation surface 114 may be lowered into an interior cavity, another bottle loaded thereon, and raised again to display the new replacement bottle. In this way, vehicle system 104 provides an interactive and enriched presentation of the perfume that mimics those of traditional brick-and-mortar stores.

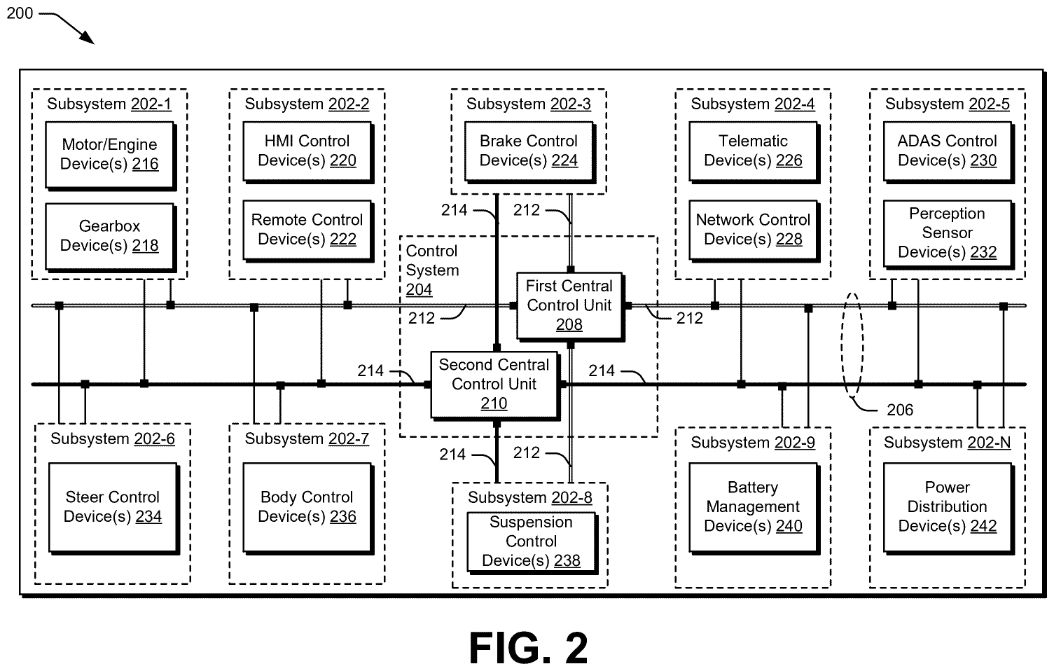

FIG. 2 is a block diagram of a non-limiting example of a vehicle system 200 that provides an enriched presentation and waste reduction for the autonomous provisioning of goods and services.

For ease of description, the vehicle system 200 is described in the context of environment 100 shown in FIG. 1, including with reference to similarly labeled elements. For example, vehicle system 200 is a more detailed version of vehicle system 104 installed in vehicle 102. The vehicle system 200 includes a plurality of subsystems 202 (labeled individually as subsystem 202-1 through subsystem 202-N, where N is any integer) managed by a control system 204 to implement various vehicle functions. The vehicle subsystems 202 are distributed on the vehicle 102 and include one or more edge devices. In at least one example, the vehicle system 200 includes additional or fewer subsystems 202 than those depicted in FIG. 2.

The control system 204 is configured as a centralized controller that enables information to transfer between the subsystems 202 over a network 206 (e.g., a vehicle network). By exchanging information with subsystems 202, control system 204 causes subsystems 202 to execute subsystem functions that enable driving. For instance, the control system 204 receives signals output on the network 206 from one of the subsystems 202, and based on information inferred from the signals, the control system 204 outputs additional signals on the network 206 to cause a particular behavior of another of the subsystems 202.

The control system 204 includes at least two central control units 208 and 210. The control system 204 and the central control units 208, 210 are centrally located on the vehicle 102 relative the edge devices and the vehicle subsystems 202, in at least one example. In at least one other example, the control system 204 is positioned on the vehicle 102 closer to one or more edge devices and the vehicle subsystems 202 than others. In other implementations, the control system 204 includes a single central control unit or other processing device.

The control system 204 includes a first central control unit 208 and a second central control unit 210. The first central control unit 208 and the second central control unit 210 represent separate processors, processor cores, control units, microcontrollers, systems on chip, or other processor technology. Each central control unit 208, 210 is configured to execute instructions either as software or firmware to implement functionality of the control system 204. Although not shown, in some examples, the control system 204 includes a non-transitory computer-readable storage medium (e.g., data store, cache, static memory, dynamic memory, flash memory, disk storage) that maintains the instructions and data for implementing the instructions executed by each of the first central control unit 208 and the second central control unit 210. For example, the first central control unit 208 and the second central control unit 210 include respective data stores that contain the instructions retrieved from the data stores and executed during the operation of vehicle 102.

Examples of the processors of the central control units 208, 210 and/or the edge devices include but are not limited to a central processing unit (CPU), graphics processing unit (GPU), field programmable gate array (FPGA), accelerator, accelerated processing unit (APU), and system on chip (SoC), microcontroller, electronic control unit (ECU), and digital signal processor (DSP), to name a few. In one or more variations, the processors of the central control units 208, 210 and/or the edge devices include multiple co-processors or multiple cores (e.g., a multi-core processor). In one or more other variations, the processors of the central control units 208, 210 and/or the edge devices include only one core (e.g., a single processor core).

In one or more implementations, the central control units 208, 210 include the same hardware technology. For example, the first central control unit 208 and the second central control unit 210 have identical processor technology. In one or more other implementations, the central control units 208, 210 include different hardware configurations that implement the same functionality. For example, a processor of the first central control unit 208 and the second central control unit 210 have different processor technology configured to execute identical control routines.

In another implementation, the control system 204 is distributed throughout the vehicle system 200 in two or more locations. In such a distributed implementation, the first central control unit 208 is included in a first part of the control system 204 arranged at one part of the vehicle 102 (e.g., a front portion) and the second central control unit 210 is included in a second part of the control system 204 positioned at another part of the vehicle 102 (e.g., a rear portion). In other distributed implementations, each part of the control system 204 includes one or more multiple instances of the first central control unit 208 and/or the second central control unit 210.

In one or more examples, the first central control unit 208 and the second central control unit 210 are functionally redundant. For example, the processors of each of the first central control unit 208 and the second central control unit 210 are operable to concurrently receive the same set of inputs from the subsystems 202 and concurrently send the same set of outputs to the subsystems 202. Similarly, the processors of each of the first central control unit 208 and the second central control unit 210 are operable to concurrently receive the same set of inputs from the subsystems 202 and concurrently send the same set of outputs to the subsystems 202 regardless of whether that processor is the healthiest.

The subsystems 202 of the vehicle system 200 rely on equivalent control operations of either the first central control unit 208 or the second central control unit 210 (e.g., one at a time) to actively cause vehicle operations or vehicle functions to be performed by the subsystems 202. For example, while the first central control unit 208 is orchestrating operations of the subsystems 202, the second central control unit 210 is maintained in a ready, standby state. If the first central control unit 208 fails, then the control system 204 activates the second central control unit 210 to take over and manage the subsystems 202 where the first central control unit 208 left off. When the second central control unit 210 takes over, the vehicle 102 may be forced to operate in a safe state, which can include maneuvering away from other vehicles, objects, and pedestrians to come to a controlled stop. This way, the functional redundancy implemented by the first central control unit 208 and the second central control unit 210 helps the control system 204 satisfy the ASIL-D requirements for reliability and safety. In such implementations, the first central control unit 208 and the second central control unit 210 may be located at different locations within the vehicle.

The network 206 represents any suitable vehicle network technology, including wired and wireless signal propagation mediums. The network 206 enables real-time data exchange, safety enhancements, and efficient traffic management among the components of the vehicle system 200. Network 206 can include various switches, routers, transceivers, controllers, chokes, filters, terminations, and other networking equipment beyond transmission lines, cables, wires, buses, and other signal-routing technologies. In an aspect, the network 206 adheres to an in-vehicle networking protocol. For example, the network 206 represents a combination of one or more of a controller area network (CAN), automotive ethernet network (AEN), serializer/deserializer (SerDes) network, local interconnect network (LIN), or FlexRay network (FRN).

In at least one example, to implement the redundancy of the control system 204, the network 206 includes dual physical network paths or network channels. In at least one example, the first central control unit 208 and the second central control unit 210 are operable to concurrently exchange the same set of inputs and outputs with the subsystems 202 over different respective channels (e.g., logical or physical channels) of the network 206 that link the subsystems 202 to that central control unit (e.g., processor). A network channel 212 or network path communicatively couples subsystems 202 to the first central control unit 208. A separate network channel 214 or network path communicatively links subsystems 202 to the second central control unit 210. For example, the network channel 212 is utilized by the first central control unit 208 to exchange data over the network 206, and the network channel 214 is utilized by the second central control unit 210 to exchange data over the network 206. In at least one implementation, if a failure at the first central control unit 208 is at least partially caused by a fault in the network channel 212, the second central control unit 210 is unaffected by the network fault and operable to communicate with the subsystems 202 using the network channel 214. The functional redundancy implemented by network channel 212 and network channel 214 further helps control system 204 to satisfy the ASIL-D requirements for reliability and safety.

In at least one other example, to implement the redundancy of the control system 204, the network 206 includes dual logical network paths or channels. The network channel 212 and the network channel 214 may be separate logical paths through the network 206 that communicatively link each subsystem 202 to the first central control unit 208 and the second central control unit 210 using the same physical wires. In at least one example, the first central control unit 208 and the second central control unit 210 are operable to interleave the same set of inputs and outputs concurrently exchanged with the subsystems 202 over the same set of channels (e.g., logical or physical channels) of the network 206 that link the subsystems 202 to that central control unit (e.g., processor). For example, communications two and from the first central control unit 208 and the second central control unit 210 are interleaved on a single set of wires that make up the network 206. If a failure at the second central control unit 210 and/or the network channel 214 occurs, communications from the first central control unit 208 can reach the subsystems 202 using the network channel 212. The functional redundancy implemented by interleaving network channel 212 and network channel 214 further helps the control system 204 to satisfy the ASIL-D requirements for reliability and safety.

Each subsystem 202 includes one or more edge devices operatively coupled to the network 206 to provide information to the control system 204 and receive commands from the control system 204 to implement various vehicle functions. For example, each subsystem 202 can include one or more actuators, microcontrollers, machines, or other equipment to perform specific vehicle tasks at the control of the edge devices that are contained within subsystem 202.

A subsystem 202-1 is a propulsion or drive subsystem. Motor/engine devices 216 of the subsystem 202-1 represent edge devices managed by the control system 204 to command vehicle propulsion units (e.g., an engine, a motor) to execute driving functions of the vehicle 102 (e.g., forward motion, reverse motion, acceleration, deceleration). In one or more examples, the motor/engine devices 216 manages the operations of the vehicle's engine, including fuel injection, ignition timing, emissions control, and engine health monitoring. In at least one aspect (e.g., for electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. A vehicle may include one or more instances of subsystem 202-1 (e.g., one subsystem 202-1 for each axle).

A subsystem 202-2 is a human-machine interface (HMI) subsystem. The subsystem 202-2 includes one or more HMI control devices 220 that implement a vehicle user interface. The vehicle user interface enables interaction between occupants (e.g., driver, passenger, user) of the vehicle 102 and the vehicle system 200, which enables human intervention and control of vehicle functions and driving. For example, the HMI control devices 220 control vehicle displays, vehicle dash clusters, head-up display units, haptic feedback, audible feedback, and other visual driving aids interpreted by the occupants to help with driving or ensuring safe vehicle operations. In one or more implementations, the HMI control devices 220 provide a human interface to control climate controls (e.g., heating, cooling), cabin features (e.g., infotainment, interior lighting), and other vehicle body features (e.g., windshield wipers, transmission settings, suspension settings, drive mode selection, power seating, power mirrors, power door locks). In another implementation, the HMI control devices 220 provide an interface for persons outside vehicle 102 to make purchases of displayed goods or otherwise interact with the promotion pod 108.

The subsystem 202-2 also includes one or more remote control devices 222 that allow human or machine inputs to control the vehicle 102 from outside the cabin. For example, in an autonomous or semi-autonomous vehicle context, the remote control devices 222 receive commands over a communication link with a base station (e.g., a mobile phone, a key fob, a remote computing system) to allow a human or machine operator to control the vehicle 102 as if the driving commands are provided directly to the HMI control devices 220. In hot or cold weather, the remote control devices 222 activate remote starting functions to pre-cool or pre-heat the cabin. In at least one aspect, the remote control devices 222 allow door locks to be unlocked or locked and doors, tailgates, or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to control vehicle brakes (e.g., for stopping, for decelerating). In some examples, the brake control devices 224 represent a braking control module (BCM).

A subsystem 202-4 is an onboard-vehicle communication subsystem, which manages telematics and communications within vehicle 102 and with other devices located outside vehicle 102. For example, the subsystem 202-4 interfaces with the various edge devices coupled to the network 206 to ensure a healthy exchange of data free of errors or faults. In addition, the subsystem 202-4 interfaces with other vehicles, mobile devices, infrastructure, and remote computing systems to implement various vehicle functions. One or more network control devices 228 of subsystem 202-4 monitor the network health of network 206 and facilitate communication protocols implemented therein. The network control devices 228 are configured to diagnose problems with network 206 to reroute signals and prevent data loss.

One or more telematic devices 226 of the subsystem 202-4 handle offboard or external communications. This includes implementing vehicle-to-vehicle (V2V) and vehicle-to-everything (V2X) communications that enable vehicle 102 to communicate with other intelligent vehicles and systems in an operating environment (e.g., on or near a roadway). The telematic devices 226 interface with over-the-air (OTA) update services to update the software on the vehicle 102. In addition, the telematic devices 226 interface with a positioning system to assist with navigation functions. Other features implemented by the telematic devices 226 include remote diagnostics and interfacing with emergency response services (e.g., to alert emergency responders automatically in the event of an accident).

A subsystem 202-5 is an advanced driving and safety (ADAS) subsystem of the vehicle system 200. The subsystem 202-5 has two main functions, including implementing an ADAS and a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving. For example, a radar, a camera, a lidar, an ultrasonic sensor, a global position system (GPS) sensor, an inertial measurement unit (IMU), and other sensor technology are deployed by the perception sensor devices 232 to collect sensor data about a vehicle environment. Sensor fusion techniques, object detection, lane centering, path trajectory planning, and other perception sensor functions are executed by the perception sensor devices 232 to enable ADAS control devices 230 to perform ADAS functions.

A subsystem 202-6 is a steering subsystem that controls elements of the vehicle to steer the wheels. One or more steer control devices 234 integrate with an electric power steering system of vehicle 102 to control the direction of the vehicle wheels. The steer control devices 234 receive inputs from the HMI control devices 220 and/or the control system 204, which are translated into appropriate steering commands for controlling steering actuators that change the wheels' direction for steering and performing evasive maneuvers.

A subsystem 202-7 (e.g., the body control subsystem 106 of FIG. 1) represents a body control subsystem of the vehicle 102. Included in the subsystem 202-7 are one or more body control devices 236, which oversee functions related to vehicle body controls. For example, window actuators, door locks and latches, interior and exterior lighting, tailgate and trunk latches, and the like are controlled by the body control devices 236 at the command of the control system 204 and/or one or more of the other subsystems 202 (e.g., the HMI control devices 220). The subsystem 202-7 control the presentation environment of the promotion pod 108 and its components, including the display screens 110, lights 112, presentation surface 114, audio system 116, lockers 118, and pod cover 120. In other implementations, the subsystem 202-7 may control additional or fewer body control devices 236 to provide an enriched presentation and waste reduction for the autonomous provisioning of goods and services.

A subsystem 202-8 is an active suspension control subsystem. One or more suspension control devices 238 implement functions of a suspension control module (SCM) to regulate suspension components to adjust the ride level of the vehicle 102. For example, suspension control devices 238 configure a vehicle suspension to be stiffer on paved surfaces for improved driving performance and maneuverability. In an offroad setting, the suspension control devices 238 enable a softer suspension setting to provide a smoother ride.

A subsystem 202-9 represents a battery management subsystem of the vehicle 102. One or more battery management devices 240 monitor the performance of a battery pack (also referred to as a traction battery) to ensure appropriate charging and discharging rates to promote longevity and overall battery health. The battery management devices 240 control charging operations of onboard vehicle batteries as well as controlling battery usage (e.g., to control a rate of discharge). The battery management devices 240 monitor the health of vehicle batteries to alert the control system 204 when a malfunction is imminent or occurs.

Finally, a subsystem 202-N is depicted in FIG. 2, representing a power distribution system. One or more power distribution devices 242 of the subsystem 202-N manage the distribution of electrical power from energy sources on the vehicle 102 to the vehicle system 200. For example, the power distribution devices 242 control power switches, inverters, converters, and other electrical distribution components to ensure the subsystems 202 receive an appropriate current and voltage level for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor/engine devices 216 and the battery management devices 240 to manage safe electrical conditions throughout the vehicle system 200.

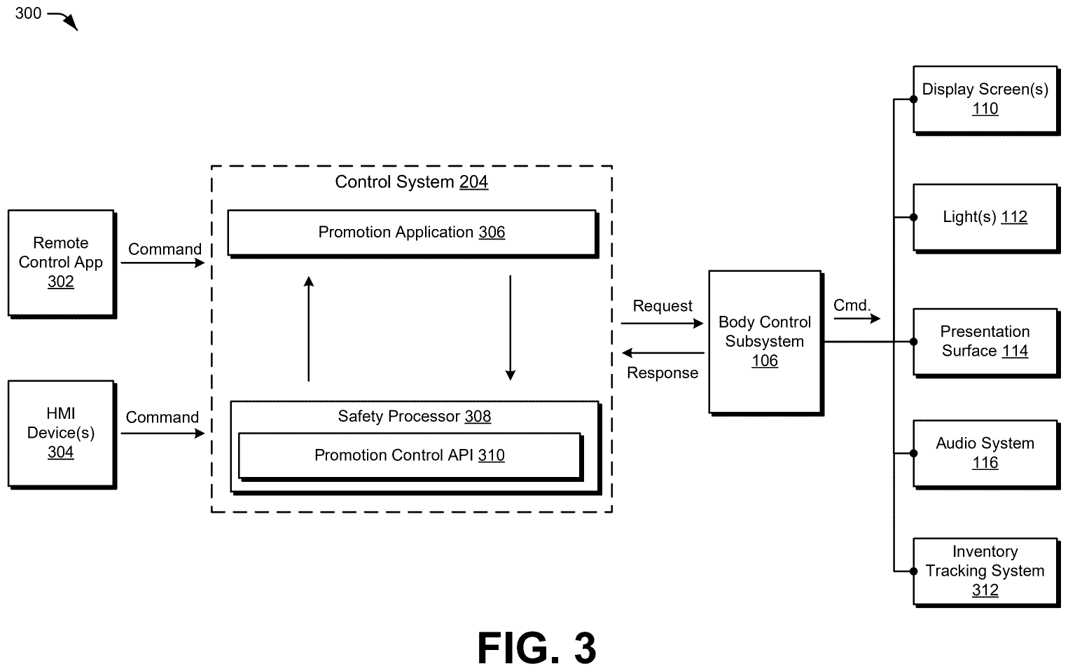

FIG. 3 depicts an example block diagram 300 for implementing techniques for an enriched presentation and waste reduction for the autonomous provisioning of goods and services.

The illustrated block diagram 300 includes the body control subsystem 106 and the control system 204 of FIGS. 1 and 2, respectively. The block diagram 300 also includes a remote control application 302, one or more HMI devices 304, a promotion application 306, a safety processor 308, and a promotion control application programming interface (API) 310. The body control subsystem 106 is communicatively coupled to the display screens 110, lights 112, presentation surface 114, audio system 116, and inventory tracking system 312. It is to be appreciated that different configurations of the vehicle 102 may have different components and subsystems as part of the block diagram 300.

The remote control application 302 is a custom or third-party application available on a remote computing device (e.g., a smartphone), which may be used to complete purchases, request a demonstration of a displayed good, view inventory items available in vehicle 102, open a locker 118 to retrieve ordered goods, and so forth. One example of the HMI device 304 is a touch screen on an exterior portion of vehicle 102 as part of the promotion pod 108. Similarly, the HMI device 304 allows users to complete purchases, request a demonstration, view inventory items, open a locker 118, and so forth. The remote control application 302 and/or HMI device 304 may also allow remote users to send presentation or promotion criteria to the promotion pod 108. In at least one scenario, input is received via the remote control application 302 or HMI device 304 (e.g., a touch input in relation to a displayed interactive element for setting up a specific display configuration or carrying out a specific command). Responsive to such input, the HMI device 304 communicates a command to the control system 204. For example, the command is provided from the remote control application 302 or the HMI device 304 to the promotion application 306 and forwarded to the body control subsystem 106.

In accordance with one implementation, the command from the remote control application 302 or the HMI device 304 is not simply forwarded to the targeted subsystem (e.g., the body control subsystem 106) to cause it to perform the commanded operation. Instead, the command is filtered by a safety processor 308 to ensure that performing the operation is safe given the state (e.g., parked near a roadway) of vehicle 102, permissible given the location of the vehicle, or otherwise authorized. To ensure the operation's safety or permissibility, the promotion application 306 submits a request for arbitration via the promotion control API 310. In one or more implementations, the promotion application 306 is not directly connected to one or more subsystems (or any subsystems) of vehicle 102 or promotion pod 108. Instead, the safety processor 308 is directly connected (e.g., via wired connections) to the subsystems of vehicle 102 (e.g., there are direct physical connections between I/O ports of the safety processor 308 and the subsystems), including the body control subsystem 106. Due to this architecture, in order to actuate a subsystem or related device or component, any request or command from the remote control application 302, the HMI device 304, or the promotion application 306 for a subsystem to perform an operation is channeled through the safety processor 308.

The safety processor 308 and/or the promotion control API 310 determines whether a requested operation satisfies safety, regulatory rules, or promotion parameters. An example regulatory rule may be that a country, state, or other territory does not allow vehicles to emit lights to the side while parked on or near a public roadway. If the requested operation is determined to satisfy the relevant safety or regulatory rules or authorized by promotion parameters set by a vendor of the goods 122 or owner of the vehicle 102, the safety processor 308 submits a command to the body control subsystem 106 to perform the operation, e.g., to the display screens 110, lights 112, presentation surface 114, audio system 116, and/or inventory tracking system 312. If the requested operation is determined not to satisfy the safety or regulatory rules, the request is denied, and the safety processor 308 discards the request.

As described above, the display screens 110 may be controlled to display visual indicators (e.g., images and videos) associated with goods 122 being displayed. In some instances, such visual indicators may additionally and/or alternatively be displayed by the remote control app 302 or the HMI device 304. The visual indicators may also coordinate with the illumination by the lights 112 or audio messages output by the audio system 116.

The inventory tracking system 312 tracks the removal of goods from the presentation surface 114 or vehicle compartments (e.g., lockers 118 or bins). In some implementations, the inventory tracking system 312 may be used to verify completion of transactions. The inventory tracking system 312 may employ a combination of any image recognition (e.g., via machine learning), QR code and/or RFID tag scanning, and weight and/or position sensing to support inventory tracking or determine the packaging status of goods.

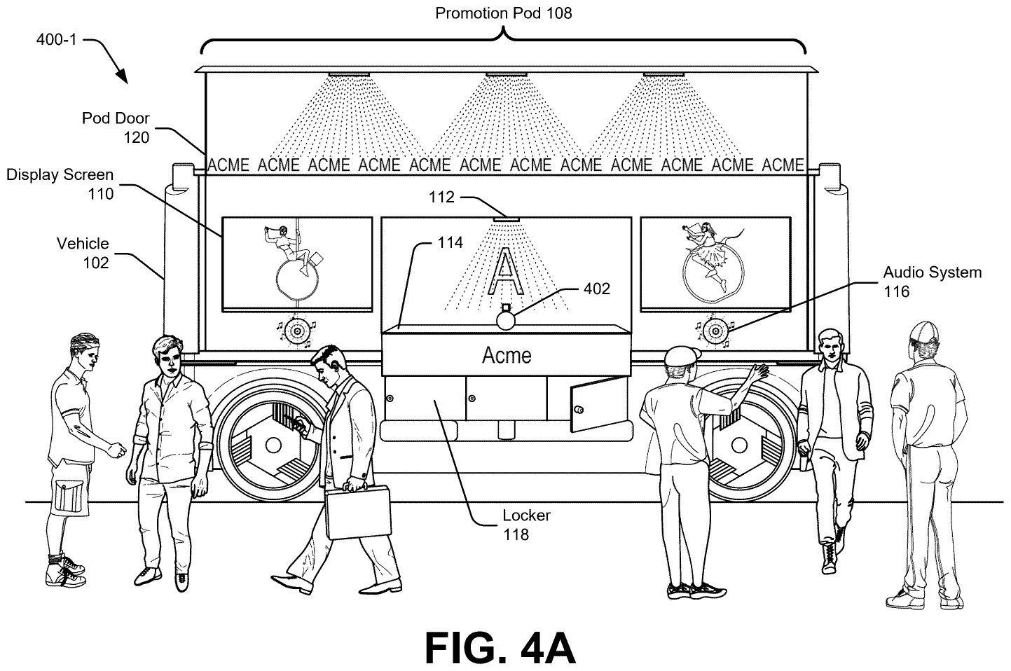

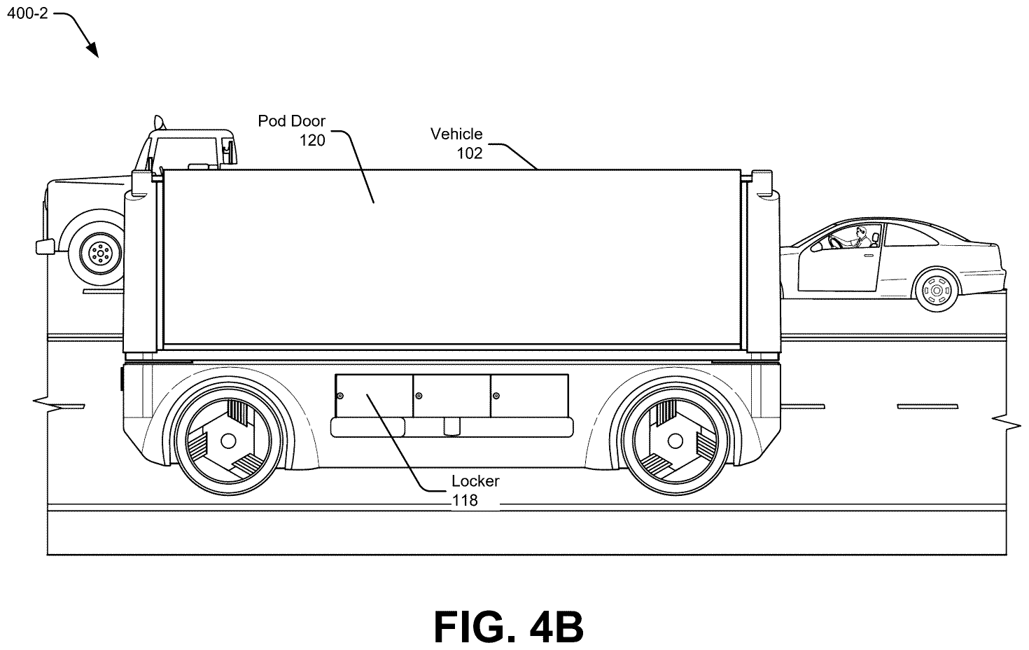

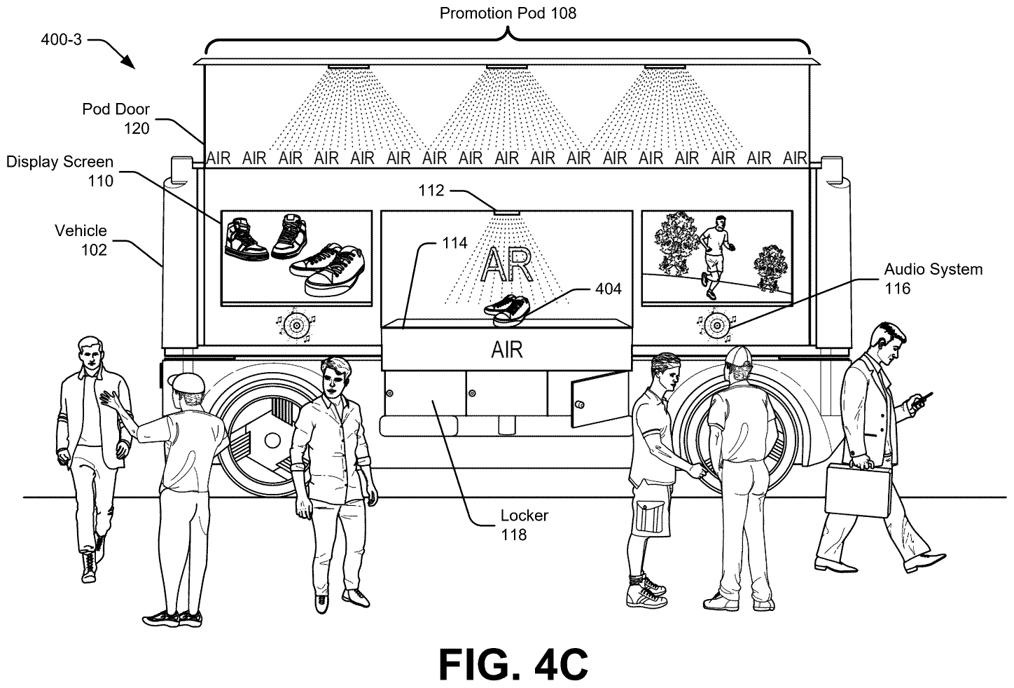

FIGS. 4A through 8 illustrate Examples of commands provided by the body control subsystem 106 to provide an enriched presentation and waste reduction for autonomous provisioning. In particular, FIGS. 4A through 8 illustrate different manners in which the display screens 110, lights 112, presentation surface 114, audio system 116, and inventory tracking system 312, including potentially fewer or additional components, are coordinated to improve user experiences and promote various goods and services.

FIGS. 4A-4C illustrate non-limiting examples 400-1, 400-2, and 400-3, respectively, of a vehicle system 104 that enables an enriched presentation and waste reduction for the autonomous provisioning of goods and services. In summary, FIG. 4A illustrates a first example 400-1 of the vehicle system 104 promoting a perfume in a crowded environment. FIG. 4A illustrates the same environment as environment 100 of FIG. 1. FIGS. 4B and 4C then illustrate vehicle 102 traveling to a new area and promoting a different product (e.g., shoes) in another environment, respectively.

As depicted in FIG. 4A, vehicle 102 is parked in a busy area with nearby pedestrians. Once parked, vehicle system 104 provides instructions to the body control subsystem 106 to promote a new perfume 402. In particular, the pod cover 120 is raised or opened to expose the display screens 110 and presentation surface 114. In some implementations, the pod cover 120 is raised after the display screens 110, presentation surface 114, and perfume 402 are set up for the promotion pod 108. An example of the perfume 402 is placed on the presentation surface 114, which extends out from the side of vehicle 102 in example 400-1. The display screens 110 indicate the manufacturer or distributor using at least one of their name, trademark, logo, color scheme, and/or slogan. The display screens 110 can also provide images or videos to promote the perfume 402, and the lights 112 emphasize or highlight the perfume 402. Other lights 112 can emphasize the manufacturer's name and call attention to vehicle 102. The audio system 116 can also play messages synced with the imagery on the display screens 110.

In FIG. 4B, the vehicle 102 has closed the pod cover 120 and is traveling to a new destination. During the commute, the perfume 402 is stowed away to prevent damage. In this way, vehicle 102 may travel to multiple sites to promote the same or different goods. For example, in a dense business location, vehicle 102 can promote perfume, flowers, jewelry, cologne, or other gifts for workers to purchase during and around typical lunch hours. Once the lunch-hour rush has passed, vehicle 102 may travel to a different site to promote cooking appliances at an evening food festival.

In FIG. 4C, the vehicle 102 is parked at another busy area to promote a different good: a new line of shoes 404 in example 400-3. The display screens 110, lights 112, and audio system 116 have been updated to promote the shoes 404. In some implementations, the promotion pod 108 includes internal machinery (e.g., robot, robotic arm, or moveable surfaces) to stow away and pull out goods 122. In this way, the vehicle 102 may leave a central site (e.g., distribution hub) in the morning and promote several goods at different locations throughout the day without having to travel back to the central site. Similarly, the different configurations of the promotion pod 108 may be remotely controlled or loaded into the control system 204, allowing vehicle 102 to provide autonomous provisioning without needing a person to change its setup or alter the displayed goods 122.

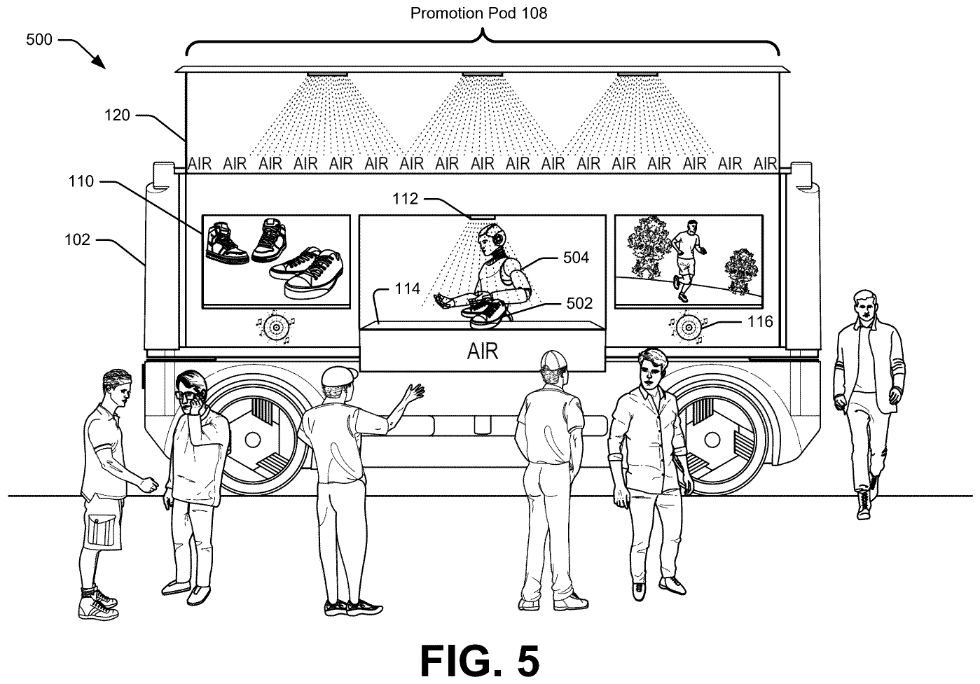

FIG. 5 illustrates another non-limiting example 500 of a vehicle system 104 that enables an enriched presentation and waste reduction for the autonomous provisioning of goods and services. As depicted in FIG. 5, vehicle 102 is parked in a busy area promoting a pair of shoes 502, similar to example 400-3 illustrated in FIG. 4C. In example 500, a humanoid robot 504 is behind the presentation surface 114. In other implementations, the humanoid robot 504 may be replaced by a robotic arm or other robotic equipment. In yet other implementations, the humanoid robot 504 is replaced by a person (e.g., a driver of the vehicle 102). The humanoid robot 504 may be configured with machine learning and artificial intelligence models to promote life-like interactions with users and pedestrians. For example, the humanoid robot 504 may be able to answer questions about the shoes 502, pull out a certain size of the shoes 502 for a person to try on or purchase, remove packaging from a purchased pair of shoes 502, stow away the shoes 502 before vehicle 102 departs, and so forth.

In other implementations, the humanoid robot 504 may offer a service to users, including bartending or providing snacks. In lieu of the shoes 502, the humanoid robot 504 may promote services (e.g., kitchen remodels) and interact with users to answer questions, schedule appointments, or provide estimates.

Once parked, vehicle system 104 provides instructions to the body control subsystem 106 and the humanoid robot 504 to promote the shoes 502. In particular, the pod cover 120 is opened to expose the humanoid robot 504, display screens 110, and presentation surface 114. The humanoid robot 504 places an example of shoes 502 on the presentation surface 114. The display screens 110 indicate the shoes' brand name, provide images of similar shoes provided by the manufacturer, and display an advertisement with a runner wearing the shoes 502. The lights 112 highlight the shoes 502 and the promotion pod 108. The audio system 116 plays messages synced with the imagery on the display screens 110. In this way, the humanoid robot 504 can enhance the presentation of goods and services by providing an interactive experience and automating various techniques.

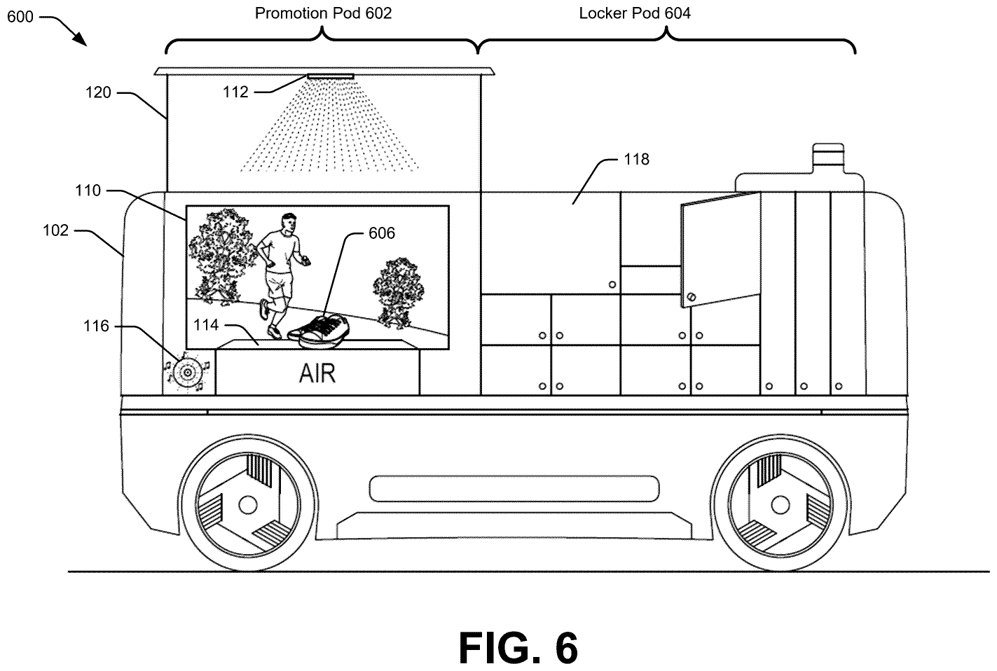

FIG. 6 illustrates a non-limiting example of a vehicle 600 that enables an enriched presentation and waste reduction for the autonomous provisioning of goods and services as part of a delivery service. As depicted in FIG. 6, the side of vehicle 600 includes promotion pod 602 and multiple bins or lockers 118 in locker pod 604. In the illustrated implementation, about half of the side is dedicated to the promotion pod 602 and the other half to the locker pod 604. In other implementations, the promotion pod 602 may take up a greater or lesser amount of the vehicle side. In this way, vehicle 102 provides autonomous provisioning of goods and services to users at their homes, work, or other selected locations, while still allowing for the enriched presentation of other goods and services. In other implementations, vehicle 600 can function similarly to vehicle 102 of FIG. 5 to promote a particular good but includes different versions of the promoted good or common accessories available for purchase in the lockers 118.

In the illustrated example, vehicle 600 is parked near a user's home and delivers items purchased online by the user. Delivering the ordered goods via the autonomous vehicle 600 them to be placed into the lockers 118 without shipping packaging. In some implementations, the user can also select during the purchase process (or later) to have the original packaging removed prior to or at the time of delivery. Alternatively, vehicle 600 can include a locker 118, which is dedicated to collecting unwanted packaging from users as part of the delivery process. In this way, the described techniques and systems allow goods to be delivered with fewer packaging materials and provide a convenient means for recycling unwanted packaging materials. The vehicle's owner or distributors can reuse or recycle these packaging materials for other deliveries.

The promotion pod 602 includes two display screens 110, lights 112, presentation surface 114, and audio system 116 that are revealed when pod cover 120 is opened. Here, shoes 606 are being promoted to the user in connection with their delivery. The user may have previously indicated they were interested in purchasing running shoes. In response, promotion pod 602 presents a small number of shoes (e.g., one to three different pairs) for the user to consider and potentially purchase. The promoted shoes can be based on user input, past user preferences, recent shopping trends of other users, or incentives provided by manufacturers, among many other potential solutions. In this way, vehicle 600 brings a focused, small shoe store to the user to allow them to try different pairs in real-time and purchase the desired pair. If the displayed shoes are not the correct size, vehicle system 104 can stock different sizes in one of the lockers 118. Users can complete their purchase via the remote control app 302 on their smartphone, HMI device 304 (not illustrated in FIG. 6), or via a link provided by a QR code.

Alternatively, the display goods (e.g., shoes 606) are part of a promotional event. For example, vehicle 600 may be making a number of deliveries in the same neighborhood, and based on geographic or user profile data, it may be determined that promoting a particular good should have a high conversion success rate. Alternatively, the goods can be selected based on an upcoming or recent holiday, weather event, popular sporting event, product release, etc. In other implementations, product manufacturers or service providers can pay for the autonomous promotion of their goods or services for a certain period, selected geographic area, or other considerations. In any of these scenarios, the promotion pod 602 allows vehicle 600 to supplement its autonomous provisioning of goods and services with a targeted shopping experience similar to those commonly found in brick-and-mortar stores.

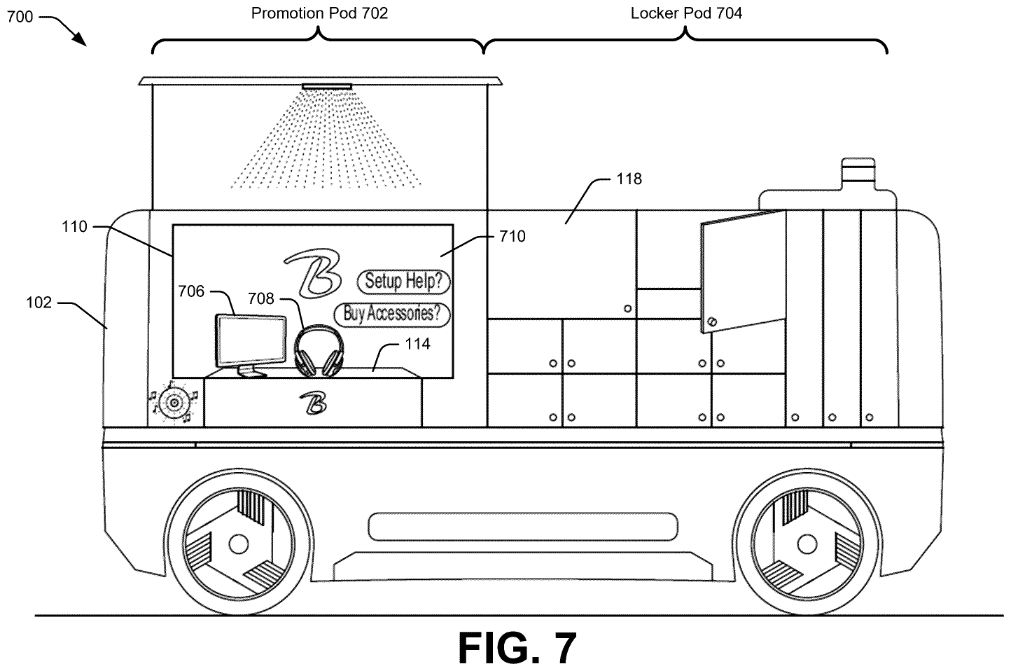

FIG. 7 illustrates another non-limiting example of a vehicle 700 that enables an enriched presentation and waste reduction for the autonomous provisioning of goods and services as part of a delivery service. In this example, vehicle 700 delivers via lockers 118 in the locker pod 704 a laptop recently ordered online by the user. The promotion pod 702 is arranged to display common accessories purchased with laptops that may interest the user, including a monitor 706 and headphones 708. The monitor 706 and headphones 708 (or other accessories not illustrated) are available for purchase. In some implementations, the vehicle 102 additionally or alternatively includes the HMI screen 710 as part of the display screen 110. The HMI screen 710 allows users to set up their laptop with video or step-by-step assistance. The HMI screen 710 may also allow users to purchase any displayed accessories. In other implementations, the promotion pod 702 includes a robot or robotic equipment that allows the displayed accessories or goods to be changed from one delivery to another, thus allowing for personalized experiences to supplement autonomous provisioning.

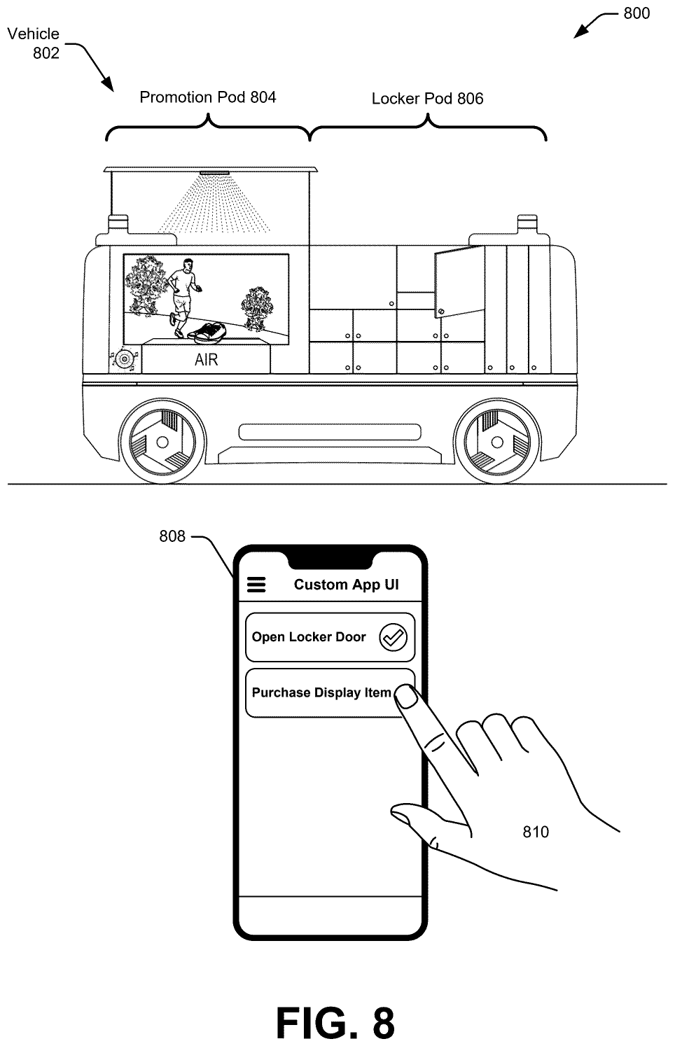

FIG. 8 illustrates a non-limiting example environment 800 of a vehicle system that enables an enriched presentation and waste reduction for the autonomous provisioning of goods and services via an application on an external computing device.

In particular, environment 800 includes vehicle 802 with promotion pod 804 and locker pod 806, which is similar to vehicle 600 of FIG. 6. The promotion pod 804 and locker pod 806 are located on top of the vehicle 802, e.g., relative to a surface on which the vehicle travels. In one or more implementations, the promotion pod 804 and/or locker pod 806 may be integral with vehicle 802 in various other ways, such as disposed on a side of the vehicle, beneath the body of the vehicle, and so on.

The illustrated environment 800 also includes an external computing device 808 (e.g., a smartphone with a custom app UI), which is operable by a user 810 external to vehicle 802. This environment 800 represents a scenario where the user 810 may provide input via a user interface displayed via the external computing device 808. In this scenario, user 810 may provide input to the user interface for controlling some operations of vehicle 802, locker pod 806, and/or promotion pod 804. For instance, user 810 may provide input via the user interface for opening a locker door of locker pod 806 (e.g., to retrieve goods being delivered or purchased via the custom app UI). In accordance with the described techniques, the external computing device 808 may communicate an indication of this input to the control system 204 over a network (not shown). Responsive to the receipt of the indication, an application of vehicle 802 (e.g., promotion application 306) corresponding to the companion application of the external computing device 808 may cause a request to be sent from the control system 204 to the safety processor(s) 308 and/or the body control subsystem 106.

Similar to vehicle 600 of FIG. 6, the promotion pod 804 in the illustrated environment 800 promotes one or more goods. The promotion pod 804 may include a display screen, lights, presentation surface, and/or audio system. The promoted goods may include those related to the user's shopping interest, a current deal, a new release, the delivered goods, etc. For example, user 810 may use the custom app UI or another application to indicate to a central computing system that they are interested in purchasing running shoes but are uncertain of a particular shoe or size. In response, the promotion pod 804 is arranged to promote a small handful of running shoes based on customer reviews, the user's purchasing history, user feedback via the central computing system, or promotional relationships. If the displayed shoes are from a single manufacturer, the display screens can illustrate promotional images or videos related to the manufacturer or the displayed shoes. The exterior lights can illuminate the different shoes. In one implementation, the lights can emphasize a shoe as the likely best fit for the user 810.

In this way, the user 810 is provided an experience similar to a brick-and-mortar store dedicated to providing running shoes. The user 810 may also interact with the external computing device 808 or an HMI screen located on vehicle 802 to change the shoes on display. Once the user 810 is ready to make a purchase, the purchase is completed on the external computing device 808 or the HMI screen. User 810 can be provided their new shoes via a locker within locker pod 806 or directly from promotion pod 804. In this way, shipping packaging is not required for the new shoes, thus reducing waste.

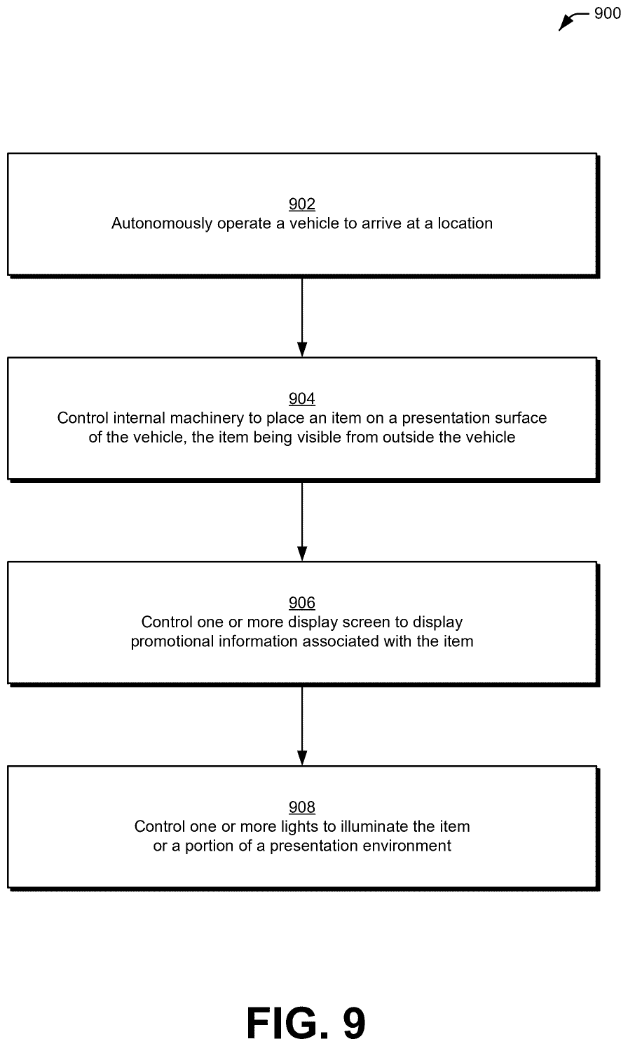

FIG. 9 depicts a procedure 900 for implementing enriched presentation and waste reduction for the autonomous provisioning of goods and services. The procedure 900 includes multiple operations illustrated as block 902 through block 908 and provides just one example procedure performed within any previously described systems (e.g., the vehicle system 104, the vehicle system 200). The procedure 900 is not limited to the order of operations shown in FIG. 9, other orderings of blocks 902 through 908 are possible. In one or more implementations, the procedure 900 includes additional or fewer operations than those depicted in FIG. 9.

Procedure 900 starts with a vehicle autonomously operated to arrive at a location (block 902). For example, the vehicle system 104 autonomously operates the vehicle 102 to drive to a location (e.g., a user's home, congested public space, business park, etc.) to promote goods and services.

Next, internal machinery is controlled to place an item on a presentation surface of the vehicle (block 904). The displayed item is visible from outside the vehicle. For example, the body control subsystem 106 causes a humanoid robot, robotic arm, robotic equipment, or moveable surfaces to place the goods 122 (e.g., perfume, shoes, smartphones, etc.) or a representation of services on a presentation surface 114. The goods 122 are visible from outside the vehicle 102 by nearby pedestrians, users, and others. In some implementations, the goods 122 are displayed without packaging.

In some implementations, the goods 122 are mechanically attached to the presentation surface 114. The vehicle system 104 is configured to control a locker 118 or other dispenser mechanism to provide a purchased item to a user from an internal inventory that is not visible from outside the vehicle 102.

One or more display screens are then controlled to display promotional information associated with the displayed item (block 906). For example, the body control subsystem 106 causes the display screens 110 to display multimedia to promote the goods 122. The multimedia may include images, videos, or a combination thereof. In some examples, the promotional information includes a logo, trademark, brand name, color scheme, trade dress, advertisement image or video, or promotional deal of the manufacturer or vendor of the goods 122 associated with the goods 122. The promotion pod 108 may also include the audio system 116 to play audio messages synced with the display screens 110 or to draw in users. The promotional information from the display screens 110 or the audio system 116 may also include a personalized image, video, or audio message for a nearby user. The promotion pod 108 may also include a HMI as part of a display screen 110 or separate therefrom to allow nearby users to purchase the goods 122 or obtain additional information about the goods 122.

Lights are also controlled to illuminate the displayed item (block 908). For example, the body control subsystem 106 controls the lights 112 to illuminate the goods 122. In some implementations, the lights 112 illuminate or emphasize a subset of the display screens 110, vehicle 102, or the area near vehicle 102.

In many implementations, the vehicle system 104 autonomously controls the promotion pod 108 and its components to autonomously setup and provide a presentation environment for specific items. For example, the vehicle system 104 controls the promotion pod 108 to provide a first presentation environment for a first item at a first location. Later in the day, the vehicle system 104 controls the promotion pod 108 provide a second (and different) presentation environment for a second item at a second location. In such scenarios, the second presentation environment, second item, and second promotional information differ from the first presentation environment, first item, and first promotional information, respectively. The instructions for the first and second presentation environments may be received from remote computer systems in some implementations.

The promotion pod 108 may also include a humanoid robot, robotic arm, or robotic equipment to remove the goods 122 from associated packaging material, receive and stow the packaging material from users, retrieve the goods 122 or copies thereof for delivery to users, and/or display different goods 122 on the presentation surface 114. If the promotion pod 108 includes a humanoid robot, it can also answer user questions, perform functions associated with the goods 122, or compete purchases of the goods 122 by users.

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the vehicle system 104, body control subsystem 106) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

1. A system comprising:
a promotion pod configured to provide a presentation environment for an item that is or is representative of a good or service, the promotion pod including:
a display screen configured to display multimedia content visible from outside the system;
a presentation surface configured to show an item, the item being a good or service; and
a light configured to illuminate at least a portion of the promotion pod; and
a processor configured to:
control the display screen to display promotional information associated with the item;
cause the light to illuminate the item or a portion of the promotion pod;
control internal machinery of the promotion pod to place the item on the presentation surface; and
control the internal machinery to remove another item from associated packaging material for placement on the presentation surface or delivery to a purchaser.

2. The system of claim 1, wherein:
the system is an autonomous vehicle; and
the processor is further configured to autonomously setup the presentation environment upon arriving at a destination.

3. The system of claim 2, wherein the processor is further configured to:
autonomously setup a first presentation environment at a first time or a first location for a first item with first promotional information associated with the first item; and
autonomously setup a second presentation environment at a second time or a second location for a second item with second promotional information associated with the second item, with:
the second presentation environment, the second item, and the second promotional information being different than the first presentation environment, the first item, and the second promotional information, respectively; and
at least one of the second time or the second location being different than the first time or the first location, respectively.

4. The system of claim 1, wherein:
the promotional information includes at least one of a brand name, logo, color scheme, trademark, trade dress, advertisement image, or advertisement video associated with the item; and
the processor is further configured to cause the presentation surface to extend laterally away from a side of the system.

5. The system of claim 4, wherein the promotional information further includes a personalized image, video, or audio message for a nearby user.

6. The system of claim 1, wherein the internal machinery is further configured to place the associated packaging material within a bin for collecting recycling material.

7. The system of claim 1, wherein:
the item is mechanically attached to the presentation surface; and
the processor is further configured to control a locker or dispenser mechanism of the system to provide a purchased item to a user from an internal inventory, the internal inventory not being visible from outside the system.

8. The system of claim 1, wherein the light includes one or more multi-wavelength light emitters having adjustable brightness or wavelength characteristics.

9. The system of claim 1, wherein the system further includes an audio system to play audio messages related to the item or the promotional information associated with the item.

10. The system of claim 1, wherein the system further includes a human-machine interface configured to allow nearby users to purchase the item or obtain more information about the item.

11. The system of claim 1, wherein the processor is further configured to control the display screen, light, and presentation surface based on instructions received from a remote computer system.

12. The system of claim 1, wherein the system further includes a humanoid robot, robotic arm, or robotic equipment configured to:
remove the item from associated packaging material;
receive and stow the associated packaging material from a user;
retrieve the item or a copy of the item for delivery to the user; or
display a different item on the presentation surface.

13. The system of claim 12, wherein the system includes the humanoid robot that is further configured to:
answer questions from the user;
perform a function associated with the item; or
complete purchases of the item for the user.

14. The system of claim 1, wherein:
the system further includes an inventory tracking system configured to determine whether the item is removed by a user from the presentation surface or a locker of the system; and
the processor is further configured to charge the user for the item in response to a purchase transaction being completed on a human-machine interface of the system or via a remote computer system.

15. A method for providing a presentation environment for an item that is or is representative of a good or service, the method comprising:
autonomously operating, by one or more processors of a vehicle system, a vehicle to arrive at a location;
controlling internal machinery of the vehicle to place the item on a presentation surface of the vehicle, the item being visible from outside the vehicle;
controlling one or more display screens to display promotional information associated with the item; and
controlling one or more lights to illuminate the item or a portion of the presentation environment; and
controlling the internal machinery to remove another item from associated packaging material for placement on the presentation surface or delivery to a purchaser.

16. The method of claim 15, wherein;
the presentation environment is autonomously setup by the vehicle system before raising a cover covering the one or more display screens, the presentation surface, or the one or more lights; and
the presentation surface is extended laterally away from a side of the vehicle system.

17. The method of claim 16, wherein the method further includes:
autonomously setting up a first presentation environment at a first time or a first location for a first item with first promotional information associated with the first item; and
autonomously setting up a second presentation environment at a second time or a second location for a second item with second promotional information associated with the second item, with:
the second presentation environment, the second item, and the second promotional information being different than the first presentation environment, the first item, and the second promotional information, respectively; and
at least one of the second time or the second location being different than the first time or the first location, respectively.

18. The method of claim 15, wherein:
the method further includes controlling the internal machinery to place the associated packaging material within a bin for collecting recycling material;
the vehicle further includes a humanoid robot, robotic arm, or robotic equipment; and
the method further includes at least two of following actions performed by the humanoid robot, the robotic arm, or the robotic equipment:
removing the item from associated packaging material;
receiving and stowing the associated packaging material from a user;
retrieving the item or a copy of the item for delivery to the user; or
displaying a different item on the presentation surface.

19. The method of claim 18, wherein:
the vehicle includes the humanoid robot; and
the method further includes an additional action performed by the humanoid robot:
answering questions from the user;
performing a function associated with the item; or
completing a purchase of the item for the user.

20. A computer-readable storage medium comprising instructions that, when executed by one or more processors, cause a vehicle control system of a vehicle to:
autonomously operate the vehicle to arrive at a location;
open a locker of the vehicle to deliver a package to a user;
control internal machinery to remove an item from associated packaging material and place the item on a presentation surface of the vehicle, the item being visible to the user from outside the vehicle on the presentation surface that extends laterally away from a side of the vehicle;
control one or more display screens to display promotional information associated with the item; and
control one or more lights to illuminate the item.
